(19) United States
(12) Patent Application Publication
(10) Pub. No.: US 2018/0166071 A1
(43) Pub. Date: Jun. 14, 2018

(54) METHOD OF AUTOMATICALLY CLASSIFYING SPEAKING RATE AND SPEECH RECOGNITION SYSTEM USING THE SAME

(71) Applicant: Electronics and Telecommunications Research Institute, Daejeon (KR)

(72) Inventors: Sung Joo LEE, Daejeon (KR); Jeon Gue PARK, Daejeon (KR); Yun Keun LEE, Daejon (KR); Hoon CHUNG, DAEJEON (KR)

(73) Assignee: Electronics and Telecommunications Research Institute, Daejeon (KR)

(21) Appl. No.: 15/607,880

(22) Filed: May 30, 2017

(30) Foreign Application Priority Data
Dec. 8, 2016 (KR) 10-2016-0167004

(51) Int. Cl. G10L 15/08; G10L 15/02; G10L 17/00

(52) U.S. Cl. CPC G10L 15/08; G10L 17/005; G10L 15/02

(57) ABSTRACT

Provided are a method of automatically classifying a speaking rate and a speech recognition system using the method. The speech recognition system using automatic speaking rate classification includes a speech recognizer configured to extract word lattice information by performing speech recognition on an input speech signal, a speaking rate estimator configured to estimate word-specific speaking rates using the word lattice information, a speaking rate normalizer configured to normalize a word-specific speaking rate into a normal speaking rate when the word-specific speaking rate deviates from a preset range, and a rescoring section configured to rescore the speech signal whose speaking rate has been normalized.

### CROSS-REFERENCE TO RELATED APPLICATION

This application claims priority to and the benefit of Korean Patent Application No. 10-2016-0167004, filed on Dec. 8, 2016, the disclosure of which is incorporated herein by reference in its entirety.

### BACKGROUND

### 1. Field of the Invention

The present invention relates to a technology for speech database classification necessary for learning of an automatic speech recognition system and acoustic model training, and more particularly, to a method of automatically classifying a speaking rate of an input speech signal using the speech signal and a speech recognition system using the method.

### 2. Discussion of Related Art

Speech recognition technology is a technology that enables a user to execute a function of a desired device or to be provided with a service using his or her voice, which is the most human-friendly and convenient way of communication, without using an input device, such as a mouse, a keyboard, or the like, when the user controls a terminal in use or uses the service in his or her daily life.

The speech recognition technology may be applied to a home network, telematics, an intelligent robot, etc., and has become more important in this era in which information devices are being miniaturized and mobility is becoming highly regarded.

Learning of an automatic speech recognition system requires speech database classification. According to a related art, such a classification is made according to a speaker's gender, a conversation/reading, etc., but it is not possible to provide a solution to a determination of a speaking rate and speech database classification based on the determination.

### SUMMARY OF THE INVENTION

The present invention is directed to providing a method of automatically classifying a speaking rate, in which it is possible to classify a speaking rate of a speech file using the speech file, estimate and normalize word-specific speaking rates, and improve speech recognition performance, and a speech recognition system using the method.

According to an aspect of the present invention, there is provided a method of automatically classifying a speaking rate, the method including: extracting word lattice information by performing speech recognition on an input speech signal; estimating syllable speaking rates using the word lattice information; and determining speaking rates to be fast, normal, and slow rates in comparison to a preset reference using the syllable speaking rates.

According to another aspect of the present invention, there is provided a speech recognition system using automatic speaking rate classification, the system including: a speech recognizer configured to extract word lattice information by performing speech recognition on an input speech signal; a speaking rate estimator configured to estimate word-specific speaking rates using the word lattice information; a speaking rate normalizer configured to normalize a word-specific speaking rate into a normal speaking rate when the word-specific speaking rate deviates from a preset range; and a rescoring section configured to rescore the speech signal whose speaking rate has been normalized.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart illustrating a method of automatically classifying a speaking rate according to an exemplary embodiment of the present invention;

FIG. 2 is a flowchart illustrating a process of determining a syllable speaking rate according to an exemplary embodiment of the present invention;

FIG. 3 is a diagram showing a system for automatically classifying a speaking rate according to an exemplary embodiment of the present invention;

FIG. 4 is a diagram showing a system for automatically classifying a speaking rate according to another exemplary embodiment of the present invention; and

FIG. 5 is a diagram showing a speech recognition system using the method of automatically classifying a speaking rate according to an exemplary embodiment of the present invention.

FIG. 6 is a view illustrating an example of a computer system in which a method of automatically classifying a speaking rate according to an embodiment of the present invention is performed.

### DETAILED DESCRIPTION OF EXEMPLARY EMBODIMENTS

Advantages and features of the present invention and a method of achieving the same should be clearly understood from embodiments described below in detail with reference to the accompanying drawings.

However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims.

Meanwhile, terminology used herein is for the purpose of describing the embodiments and is not intended to be limiting to the invention. As used herein, the singular form of a word includes the plural form unless clearly indicated otherwise by context. The term “comprise” and/or “comprising,” when used herein, does not preclude the presence or addition of one or more components, steps, operations, and/or elements other than the stated components, steps, operations, and/or elements.

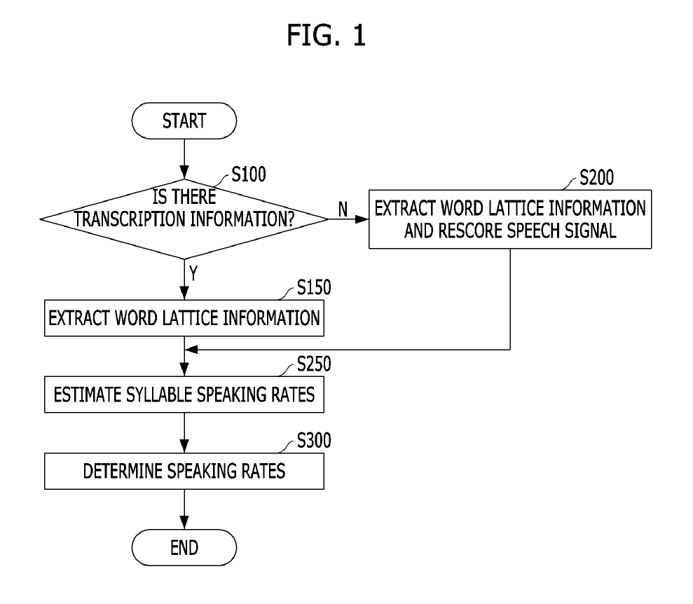

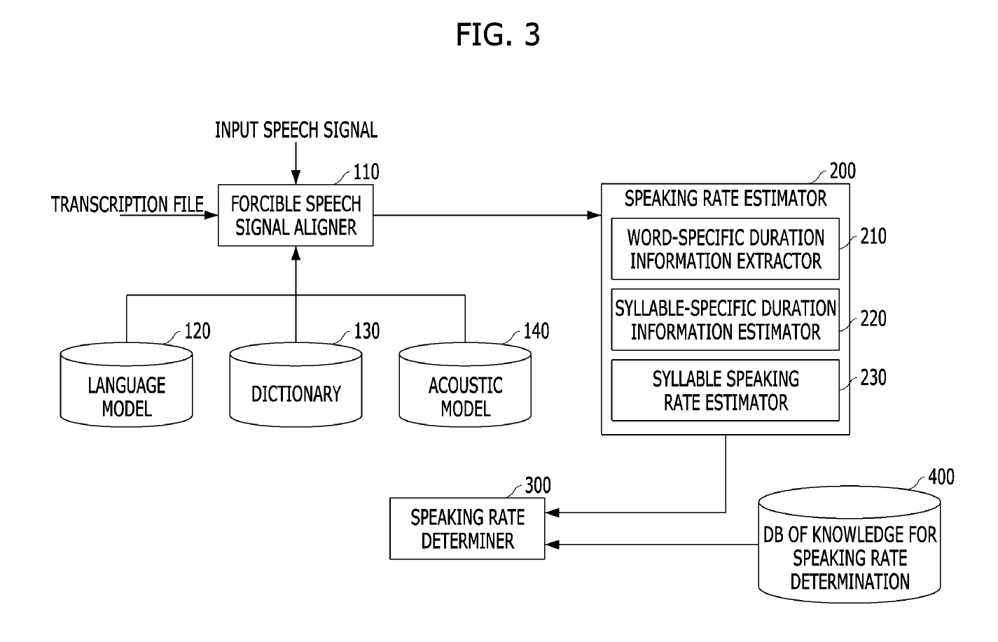

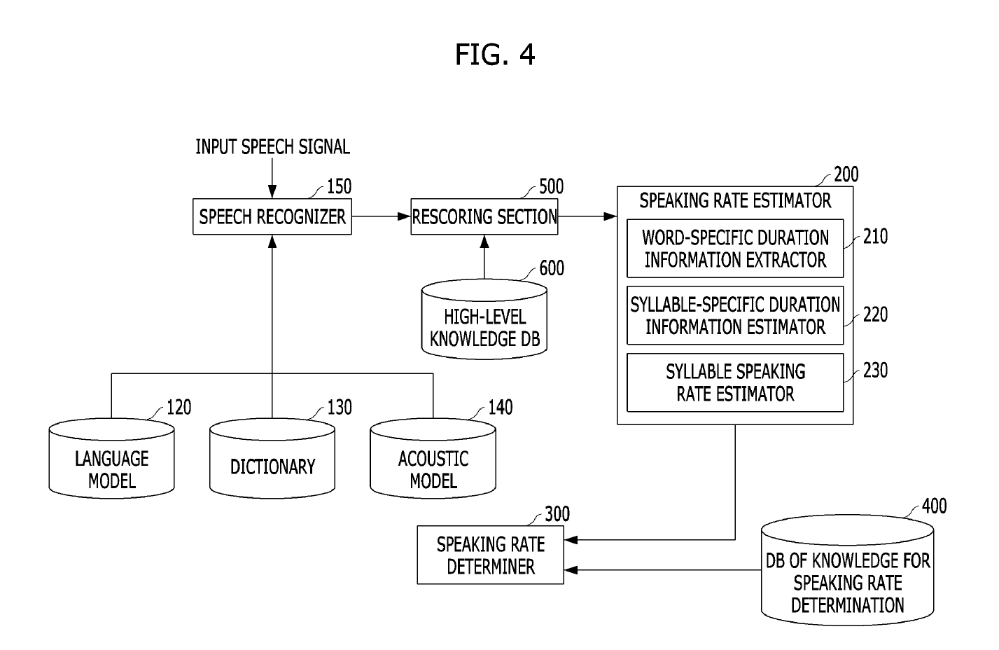

FIG. 1 is a flowchart illustrating a method of automatically classifying a speaking rate according to an exemplary embodiment of the present invention. FIG. 3 is a diagram showing a system for automatically classifying a speaking rate according to an exemplary embodiment of the present invention, and FIG. 4 is a diagram showing a system for automatically classifying a speaking rate according to another exemplary embodiment of the present invention.

A method of automatically classifying a speaking rate according to an exemplary embodiment of the present invention includes an operation of extracting word lattice information by performing speech recognition on an input speech signal, an operation of estimating syllable speaking rates using the word lattice information, and an operation of determining speaking rates as fast, normal, and slow rates in comparison to a preset reference using the syllable speaking rates.

When it is determined in operation S100 that there is transcription information, a forcible speech signal aligner 110 forcibly align an input speech signal and extracts word lattice information using the transcription information and a speech recognition system (S150).

Here, a language model 120 is a language model for automatic speech recognition generally based on a weighted finite state transducer (wFST).

A dictionary 130 of the speech recognition system is a lexicon for automatic speech recognition, and an acoustic model 140 is an acoustic model for automatic speech recognition.

When it is determined in operation S100 that there is no transcription information, a speech recognizer 150 extracts word lattice information by performing speech recognition using the aforementioned language model 120, dictionary 130, and acoustic model 140 (S200).

At this time, when general speech recognition is used, accuracy in acquiring word boundary information of a word lattice is degraded. Therefore, according to an exemplary embodiment of the present invention, the boundary information is refined using a Kullback-Leibler divergence for calculating a difference between probability distributions.

According to an exemplary embodiment of the present invention, a probability density function (PDF) is calculated from a spectrum of the input speech signal as shown in [Equation 1] below.

$$P ( k ) = \frac{{\vert X ( k ) \vert}^{2}}{{\sum }_{k = 0}^{K} {\vert X ( k ) \vert}^{2}} \qquad [ Equation 1 ]$$

Subsequently, a PDF mean, μ_{left}, μ_{right}, a covariance, Σ_{left}, and Σ_{right} are calculated from frames on the left and right of a reference frame, and then the Kullback-Leibler divergence is calculated by substituting the calculated values into [Equation 2] below.

$${D}_{KL} ( {P}_{left} \vert {P}_{right} ) = \frac{1}{2} [ tr ( {\sum }_{right}^{- 1} {\sum }_{left} ) + {( {μ}_{right} - {μ}_{left} )}^{T} {\sum }_{right}^{- 1} ( {μ}_{right} - {μ}_{left} ) - K + ln ( \frac{det {\sum }_{right}}{det {\sum }_{left}} ) ] \qquad [ Equation 2 ]$$

According to an exemplary embodiment of the present invention, it is possible to calculate new word boundary information whose Kullback-Leibler divergence has a maximum value as shown in [Equation 3] below.

$${n}_{new} = arg {max}_{i} {D}_{KL}^{i} ( {P}_{left} \vert {P}_{right} ) \qquad [ Equation 3 ]$$

At this time, a rescoring section 500 realigns the extracted word lattice information using high-level knowledge and then extracts improved word lattice information (S200).

In operation S250, syllable speaking rates are estimated using the word lattice information. A speaking rate estimator 200 includes a word-specific duration information extractor 210, a syllable-specific duration information estimator 220, and a syllable speaking rate estimator 230.

The word-specific duration information extractor 210 extracts word duration information using the word lattice information. The word duration information may have a unit of msec, by way of example.

The syllable-specific duration information estimator 220 extracts average syllable duration information from the word duration information, and the syllable speaking rate estimator 230 estimates a syllable speaking rate using the average syllable duration information.

The syllable speaking rate indicates the number of syllables spoken per unit of time (sec), and becomes a criterion of a speaking rate.

In operation S300, speaking rates are determined as fast, normal, and slow rates in comparison to a preset reference using the syllable speaking rates. A speaking rate determiner 300 classifies the speaking rates into three kinds using knowledge for speaking rate determination and the syllable speaking rates.

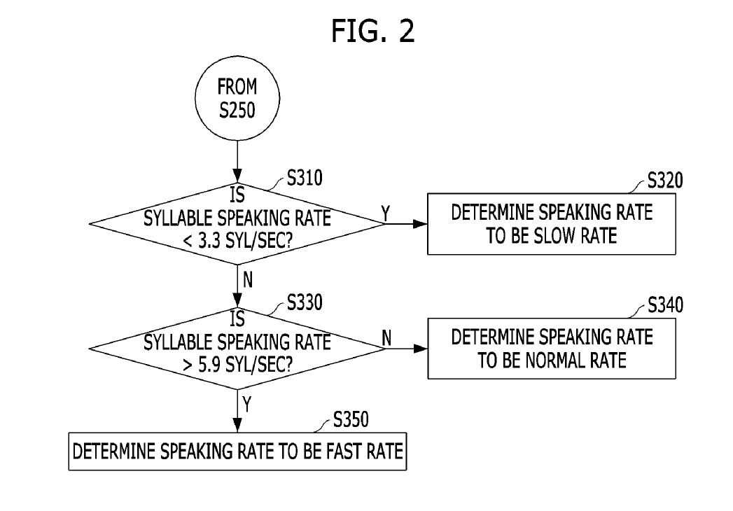

A preset range of the normal speaking rate may be determined to be 3.3 syl/sec to 5.9 syl/sec. In this case, as shown in FIG. 2, a speaking rate is determined to be the slow rate (S320) when the syllable speaking rate is less than 3.3 syl/sec, determined to be the normal rate (S340) when the syllable speaking rate is 3.3 syl/sec to 5.9 syl/sec, and determined to be the fast rate (S350) when the syllable speaking rate is faster than 5.9 syl/sec.

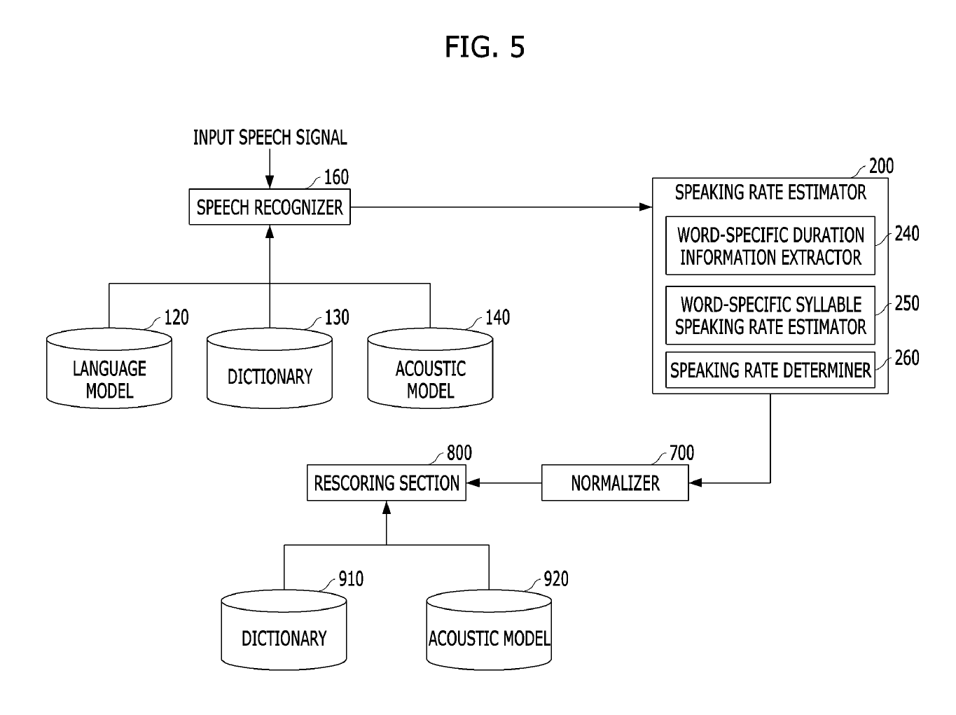

FIG. 5 is a diagram showing a speech recognition system using the method of automatically classifying a speaking rate according to an exemplary embodiment of the present invention.

A speech recognition system using the method of automatically classifying a speaking rate according to an exemplary embodiment of the present invention includes a speech recognizer 160 which extracts word lattice information by performing speech recognition on an input speech signal, a speaking rate estimator 200 which estimates word-specific speaking rates using the word lattice information; a speaking rate normalizer 700 which normalizes a word-specific speaking rate into a normal speaking rate when the word-specific speaking rate exceeds a preset range, and a rescoring section 800 which rescores the speech signal whose speaking rate has been normalized.

The speech recognizer 160 extracts word lattice information from the input speech signal using a language model 120, a dictionary 130, and an acoustic model 140. The word lattice information is, for example, a graph showing connectivity and directivity of word candidates recognized through speech recognition.

The speaking rate estimator 200 includes a word-specific duration information extractor 240, a word-specific syllable speaking rate estimator 250, and a speaking rate determiner 260.

The word-specific duration information extractor 240 extracts word-specific duration information from the word lattice information, and the word-specific syllable speaking rate estimator 250 estimates word-specific average syllable speaking rates (unit: syl/sec) using the word-specific durations.

The speaking rate determiner 260 determines word-specific speaking rates using the word-specific average syllable speaking rates. The speaking rate determiner 260 determines a word-specific average syllable speaking rate to be the normal rate when a corresponding average syllable speaking rate is within the preset range (e.g., 3.3 syl/sec to 5.9 syl/sec), and determines the word-specific average syllable speaking rate to be the fast rate or the slow rate when the corresponding average syllable speaking rate deviates from the preset range.

The speaking rate normalizer 700 normalizes a speaking rate of a word that is determined to be the fast or slow rate using a time-scale modification method.

The speaking rate normalizer 700 normalizes a speaking rate into a preset normal speaking rate (e.g., 4 syl/sec). According to a synchronized overlap-and-add (SOLA) technique among time-scale modification methods, the speaking rate is increased when a time-scale modification rate is smaller than 1.0, and is reduced when the time-scale modification rate is greater than 1.0.

When a word has a syllable speaking rate α that is slower than 3.3 syl/sec and is determined to be the slow rate, the slow speaking rate of the word is normalized into the normal speaking rate with a time-scale modification rate of 4.0/α, and when a word has a syllable speaking rate α that is faster than 5.9 syl/sec and is determined to be the fast rate, the fast speaking rate of the word is normalized into the normal speaking rate with the time-scale modification rate of α/4.0.

The rescoring section 800 rescores the speech signal whose speaking rate has been normalized using a dictionary 910 and an acoustic model 920 to acquire a final speech recognition result.

According to an exemplary embodiment of the present invention, a speaking rate of an input speech signal is automatically classified (e.g., an output parameter is 0 when the speaking rate is the normal rate, 1 when the speaking rate is the fast rate, and −1 when the speaking rate is the slow rate), the fast and slow rates of words are normalized into the normal speaking rate, and then rescoring is performed to acquire a final speech recognition result so that speech recognition performance is improved.

In a method of automatically classifying a speaking rate according to an exemplary embodiment of the present invention and a speech recognition system using the method, a speech database is automatically classified according to a speaking rate so that an analysis of the speech database, which is necessary for acoustic model training, is conducted to improve performance of the speech recognition system.

According to exemplary embodiments of the present invention, a speech database is automatically classified in consideration of a speaking rate so that a ratio of speech signals exceeding a range of a normal rate (particularly, speech signals that are faster than the normal rate) in a learning system can be appropriately adjusted.

The above description of the present invention is exemplary, and those of ordinary skill in the art should appreciate that the present invention can be easily carried out in other detailed forms without changing the technical spirit or essential characteristics of the present invention. Therefore, it should also be noted that the scope of the present invention is defined by the claims rather than the description of the present invention, and the meanings and ranges of the claims and all modifications derived from the concept of equivalents thereof fall within the scope of the present invention.

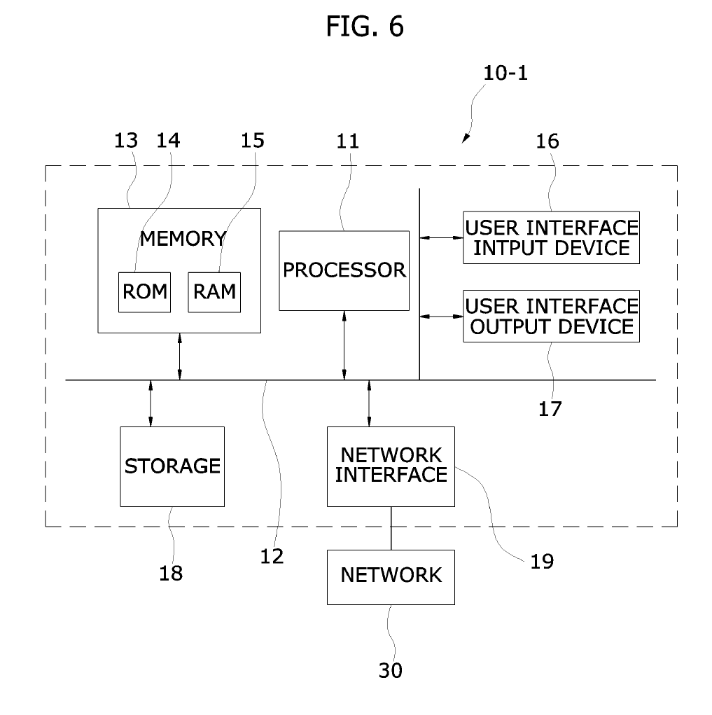

The method of automatically classifying a speaking rate according to an embodiment of the present invention may be implemented in a computer system or may be recorded in a recording medium. FIG. 6 illustrates a simple embodiment of a computer system. As illustrated, the computer system may include one or more processors 11, a memory 13, a user input device 16, a data communication bus 12, a user output device 17, a storage 18, and the like. These components perform data communication through the data communication bus 12.

Also, the computer system may further include a network interface 19 coupled to a network. The processor 11 may be a central processing unit (CPU) or a semiconductor device that processes a command stored in the memory 13 and/or the storage 18.

The memory 13 and the storage 18 may include various types of volatile or non-volatile storage mediums. For example, the memory 13 may include a ROM 14 and a RAM 15.

Thus, the method of automatically classifying a speaking rate according to an embodiment of the present invention may be implemented as a method that can be executable in the computer system. When the method of automatically classifying a speaking rate according to an embodiment of the present invention is performed in the computer system, computer-readable commands may perform the producing method according to the present invention.

The method of automatically classifying a speaking rate according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of automatically classifying a speaking rate, the method comprising:
(a) extracting word lattice information by performing speech recognition on an input speech signal;
(b) estimating syllable speaking rates using the word lattice information; and
(c) determining speaking rates to be fast, normal, and slow rates in comparison to a preset reference using the syllable speaking rates.

2. The method of claim 1, wherein (a) comprises, when there is transcription information, forcibly aligning the input speech signal using the transcription information, a language model, a lexicon, and an acoustic model and extracting the word lattice information.

3. The method of claim 1, wherein (a) comprises, when there is no transcription information, extracting the word lattice information using a speech recognition system, and
the method further comprises, between (a) and (b), (a-1) realigning the word lattice information and then extracting improved word lattice information.

4. The method of claim 3, wherein a probability density function (PDF) is calculated from a spectrum of the input speech signal, and a Kullback-Leibler divergence is calculated using data acquired from left and right frames of a reference frame so that boundary information for extracting the word lattice information is acquired.

5. The method of claim 3, wherein (a-1) comprises realigning the extracted word lattice information using high-level knowledge.

6. The method of claim 1, wherein (b) comprises extracting word-specific durations using the word lattice information, extracting average syllable duration information using the word-specific durations, and estimating the syllable speaking rates using the average syllable duration information.

7. The method of claim 1, wherein (c) comprises classifying the speaking rates using knowledge for speaking rate determination and the syllable speaking rates.

8. The method of claim 1, further comprising:
(d) acquiring a final speech recognition result by normalizing the determined speaking rates and rescoring the speech signal.

9. A speech recognition system using automatic speaking rate classification, the system comprising:
a speech recognizer configured to extract word lattice information by performing speech recognition on an input speech signal;
a speaking rate estimator configured to estimate word-specific speaking rates using the word lattice information;
a speaking rate normalizer configured to normalize a word-specific speaking rate into a normal speaking rate when the word-specific speaking rate deviates from a preset range; and
a rescoring section configured to rescore the speech signal whose speaking rate has been normalized.

10. The speech recognition system of claim 9, wherein the word lattice information is a graph showing connectivity and directivity of word candidates recognized through speech recognition.

11. The speech recognition system of claim 9, wherein the speaking rate estimator extracts word-specific duration information and estimates the word-specific average syllable speaking rates using the word-specific duration information.

12. The speech recognition system of claim 11, wherein the speaking rate estimator determines word-specific speaking rates to be normal, slow, and fast rates by determining whether the word-specific average syllable speaking rates are within a preset range.

13. The speech recognition system of claim 9, wherein the speaking rate normalizer normalizes a word-specific speaking rate faster or slower than the preset range into the normal speaking rate in consideration of a time-scale modification rate.

14. The speech recognition system of claim 9, wherein the rescoring section acquires a final speech recognition result by rescoring the speech signal whose speaking rate has been normalized using a lexicon and an acoustic model.
